(19) United States
(12) Patent Application Publication
(10) Pub. No.: US 2015/0216202 A1
(43) Pub. Date: Aug. 6, 2015

(54) PROCESS FOR PREPARING AN EXTRACT OF VEGETABLE MATERIAL, AN EXTRACT PREPARED IN THIS WAY AND ITS USE IN ANIMAL FOOD

(71) Applicant: Mars Incorporated, McLean, VA (US)

(72) Inventors: Diego Marco-Martinez, Bremen (DE); Bjorn Morr, Eystrup (DE); Gudrun Steppich, Achim (DE)

(21) Appl. No.: 14/421,790

(22) PCT Filed: Aug. 12, 2013
(86) PCT No.: PCT/EP2013/066802

§ 371 Date: Feb. 13, 2015

(30) Foreign Application Priority Data
Aug. 16, 2012 (DE) 10 2012 016 262.2

(51) Int. Cl. A23K 1/00; A23K 1/18

(52) U.S. Cl. CPC A23K 1/007; A23K 1/1846

(57) ABSTRACT

The present invention relates to a process for preparing an extract of vegetable material by at least partially fermenting the vegetable material and recovering an extract of the at least partially fermented vegetable material, the extract itself and its use.

The present invention relates to a process for preparing an extract of vegetable material, the extract itself and its use.

Animal food, especially pet food, is known with various moisture contents, such as in moist or substantially dry form. Pet food of this kind may contain various ingredients and is available in a variety of flavours. Pet food based on beef or chicken components is well-known. Meat-free pet food consisting substantially of cereals is also well-known.

There is still great potential for improvement in the taste properties of the known pet food. From W02008/135180, for example, it is known that the addition of small amounts of butyric acid or 3-methyl butyric acid to pet food can improve its taste considerably.

It is an object of the present invention to provide an alternative taste-enhancing substance which, alone or in combination with other known taste-enhancing substances, such as short-chain fatty acids, can improve the taste of pet food, which can be produced in a comparatively cheap and efficient manner, and a further object is to provide a process for manufacturing it.

The problem is solved by a process for preparing an extract of vegetable material, comprising the steps of:
a) at least partially fermenting the vegetable material, preferably under anaerobic conditions, and
b) recovering an extract of the at least partially fermented vegetable material.

In this context, it is particularly preferably contemplated that the vegetable material is selected from grass, cereal, maize, leaves and mixtures thereof, preferably grass or cereal, most preferably grass.

It can likewise be contemplated that the vegetable material in step a) is fermented in vivo, preferably in the rumen of a ruminant animal.

It is also proposed that the ruminant animal should be a cow, sheep or goat, preferably a cow.

It may further be preferable in accordance with the invention that the vegetable material is fermented under anaerobic conditions in vitro in the presence of microbial starter cultures.

In one embodiment of the invention, it is proposed that the extract in step b) is recovered by rinsing the at least partially fermented vegetable material with a solvent.

It is preferable that the solvent should be water, an aqueous solution and/or an organic solvent, preferably water.

It is likewise preferable that the temperature of the solvent should be in the range from 10 to 30° C., preferably 15 to 25° C., most preferably about 20° C.

It is preferably contemplated that the extract in step b), optionally after rinsing, is recovered by exerting a force on the at least partially fermented vegetable material and collecting an exudate.

It is particularly preferably contemplated that exertion of force on the at least partially fermented vegetable material should take the form of compressing the at least partially fermented vegetable material.

In one embodiment, it is preferred that the extract is concentrated after and/or during step b).

It is preferably contemplated that the pH of the extract is adjusted after and/or during step b).

The problem is likewise solved by an extract obtained by the process of the invention.

In addition, the problem is solved by an animal food comprising the extract of the invention.

Finally, the problem is likewise solved by the use of the extract of the invention as an additive for animal food, preferably dog food.

It has surprisingly been found that the addition of an extract in accordance with the invention to animal food, especially pet food, such as dog food, leads to a distinct improvement in the flavour compared to conventional foods, which means either that larger amounts of the food are eaten by the animal, or the animal food in accordance with the invention is eaten in preference to conventional food. In addition, it has surprisingly been found that the extract of the invention can be prepared in a simple manner and at the same time at low cost.

In particular, it is possible, for example, to recover this kind of extract of partially fermented grass from the rumen of a cow. Large quantities of partially fermented grass of this kind are obtained in slaughterhouses, where it has so far been regarded as a waste product that cannot be put to meaningful use.

In the context of the present invention, the term “pet food” is intended to mean an animal food that is used for feeding dogs, cats, rabbits or guinea pigs, for example.

The animal food of the invention can be produced by first preparing pet food according to a conventional method and adding the extract of the invention to the pet food in appropriate quantities in a subsequent step, wherein said pet food may be either dry or moist.

Further features and advantages of the method of the invention will become clear from the following detailed description of preferred embodiments, especially against the background of the worked embodiments and Figures, where

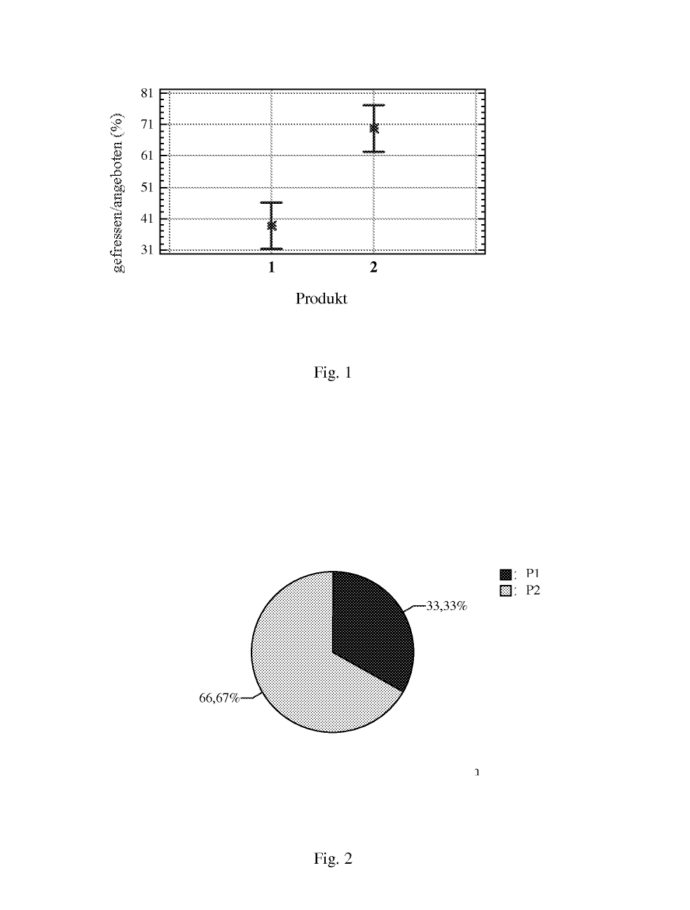

FIG. 1 shows a comparative illustration of the eating behaviour of dogs compared to untreated animal food (Product 1) and animal food treated with an extract in accordance with the invention (Product 2) when the two are offered at the same time; and

FIG. 2 shows a further comparative illustration of the eating behaviour of dogs compared to untreated animal food (P1) and animal food treated with an extract in accordance with the invention (P2) when the two are offered at the same time.

### EXAMPLE 1

Partially fermented grass was recovered directly from the rumen of a cow and used to prepare the extract without further treatment.

50 kg partially fermented grass was rinsed by spraying with 50 l water and the rinsing water recovered. A clear extract was obtained. The extract could be used directly to prepare/process a gravy for an animal food in accordance with the invention.

### EXAMPLE 2

A highly concentrated, green extract was obtained by compressing 50 kg of partially fermented grass with a force of 35 kg/cm². A partially fermented grass can be obtained in a manner which is well-known in the art, for example by adding suitable enzymes and/or microbial cultures (starter cultures, or starters for short) to fresh grass in order to initiate fermentation under anaerobic conditions. 15 l of a green extract were obtained, which was subsequenly used as an animal food additive by diluting with water in various concentrations. The extract was used in concentrations of 0.01 1/100 1 aqueous phase of the product (gravy) to 0.1 1/100 1 aqueous phase of the product (gravy).

### EXAMPLE 3

Various animal food samples were treated with the extracts in accordance with the invention. By applying a multifactor variance analysis, it was possible, as is shown in FIGS. 1 and 2 by way of example, to demonstrate a positive effect on the tastiness of the food for dogs.

FIGS. 1 and 2 show a comparison of the eating behaviour of dogs compared to untreated, prior-art dog food (product 1) and dog food treated with the extract of the invention in accordance with Example 1 (product 2). Product 1 is a standard commercial dog food based on chicken, which was prepared according to a process known in the state of the art. A process known in the state of the art includes, for example, comminuting meat/meat by-products, followed by adding additives in the form of powders and/or liquids, filling the mixture prepared into appropriate containers and sterilising it. Experts in the field are familiar with corresponding processes.

The animal food referred to as product 2 was prepared in the same way, with the only exception that small amounts of the extract of the invention, prepared in accordance with Example 1, were added. The extract prepared in Example 1 was mixed with the other ingredients in a liquid phase (gravy).

In order to compare the tastiness of the two products 1 and 2, the same amounts of the two products were offered to a significant number of dogs of different breeds for them to eat. The uneaten left-overs were analysed quantitatively in order to draw conclusions about any possible preferred eating behaviour of the animals.

As can be clearly seen from FIGS. 1 and 2, with the addition of the extract in accordance with the invention, a distinct preference for the treated animal food was recorded. About twice the amount of treated animal food was eaten compared to untreated animal food.

Similar results were also obtained using other standard commercial animal foods and/or using an extract according to Example 2.

The features of the invention disclosed in the above description, in the claims and in the drawing can be essential to implementing the invention in its various embodiments both individually and in any combination.

1. A process for preparing an extract of vegetable material, comprising the steps of:
a) at least partially fermenting the vegetable material, preferably under anaerobic conditions, and
b) recovering an extract of the at least partially fermented vegetable material.

2. The process as claimed in claim 1, wherein the vegetable material is selected from grass, cereal, maize, leaves and mixtures thereof, preferably grass or cereal, most preferably grass.

3. The process as claimed in claim 1, wherein the vegetable material in step a) is fermented in vivo, preferably in the rumen of a ruminant animal.

4. The process as claimed in claim 3, wherein the ruminant animal is a cow, sheep or goat, preferably a cow.

5. The process as claimed in claim 1, wherein the vegetable material is fermented under anaerobic conditions in vitro in the presence of microbial starter cultures.

6. The process as claimed in claim 1, wherein the extract in step b) is recovered by rinsing the at least partially fermented vegetable material with a solvent.

7. The process as claimed in claim 6, wherein the solvent is water, an aqueous solution and/or an organic solvent, preferably water.

8. The process as claimed in claim 6, wherein the temperature of the solvent is in the range from 10 to 30° C., preferably 15 to 25° C., most preferably about 20° C.

9. The process as claimed in claim 1, wherein the extract in step b), optionally after rinsing, is recovered by exerting a force on the at least partially fermented vegetable material and collecting an exudate.

10. The process as claimed in claim 9, wherein the exertion of force on the at least partially fermented vegetable material takes the form of compressing the at least partially fermented vegetable material.

11. The process as claimed in claim 1, wherein the extract is concentrated after and/or during step b).

12. An extract obtained by the method as claimed in claim 1.

13. An animal food comprising the extract as claimed in claim 12.

14. Use of the extract as claimed in claim 12 as an additive for animal food, preferably dog food.
